(19) United States
(12) Patent Application Publication
(10) Pub. No.: US 2014/0289372 A1
(43) Pub. Date: Sep. 25, 2014

(54) METHODS AND SYSTEMS FOR CONTENT DELIVERY

(71) Applicant: Infosys Limited, Bangalore (IN)

(72) Inventors: GAURAV MITTAL, DELHI (IN); ADARSH, Gurgaon (IN); SUMEET HANSPAL, Bangalore (IN); SAMARTH NARAYAN, LG Halli (IN)

(73) Assignee: Infosys Limited, Bangalore (IN)

(21) Appl. No.: 14/214,044

(22) Filed: Mar. 14, 2014

(30) Foreign Application Priority Data
Mar. 21, 2013 (IN) 1232/CHE/2013

(51) Int. Cl. H04L 29/08

(52) U.S. Cl. CPC H04L 67/06
USPC 709/219; 709/217

(57) ABSTRACT

Embodiments of the present invention relate to method and system for transferring media content between two telecommunication devices. The method recited in the invention is for delivering media content from a first telecommunication device to a second telecommunication device. At the first step of the method, the first telecommunication device (FTD) sends a media content request to a second telecommunication device (STD). The second device checks the compatibility parameters of the first telecommunication device. If the first device is competent to receive the media content, a non-data delivery channel get utilized between the two devices and the content get delivered from the second device to the first device through the non-data channel.

### RELATED APPLICATION DATA

This application claims priority to India Patent Application No. 1232/CHE/2013, filed Mar. 21, 2013, the disclosure of which is hereby incorporated by reference in its entirety.

### FIELD OF THE INVENTION

The invention relates generally to a method and system delivering content on a hand-held device. More particularly, the present invention relates to the delivery of various media content, such as songs, pictures, etc., to a mobile phone through a non-data communication channel

### BACKGROUND

Delivery of content using digital media has become the primary means of content distribution. Content of all types like images, audio, video, animations, ringtones, screensavers, textual, etc. is primarily delivered using digital media. The delivery of digital content to a mobile device happens through an active data connection, which establishes the link between the client and the server facilitating the transfer. The conventional content delivery process initiates when a user sends a request for particular media content to a content server. In response of the request, the content server sends a push SMS with a download link to the user device. The content server can also send the download link without receiving any request from the user device as a promotional content. The user clicks on the download link and a communication channel through a wireless data network establishes between the user device and the content server. Then the content server start delivering data packets of the digital content on the user device. After receiving all the data packets of the requested content, the user is in a position to experience the content. The server may or may not ensure that the content works on the device from where the request originated.

Above-mentioned conventional content delivery process has lot of limitations. The biggest limitation is need of an active data channel between the server and the user device. In other words, the download link can be accessed to facilitate transfer of the selected content to the user device only if a data connection is active on the device. In addition to this, the user will get charged for clicking the download link irrespective of the fact the content get fully downloaded on the user device or not. That means, if a user clicks on the received download link then the amount for downloading the content will be charged from the user without checking that the content downloaded is working accurately on the user device or not.

Another limitation of the conventional delivery method is that, the content server does not ensure that the content requested or pushed to the user's device necessarily works on it. In other words, the content server does not check for the compatibility of the user device in light of the requested or pushed media content.

Considering the limitations of the conventional media content delivery process, there is a strong need of a method and system for delivery the media content, which can overcome the limitations, recited above

### SUMMARY OF THE INVENTION

Disclosed are method and system for solving the above-mentioned problems by delivering media content from a content server to a handheld device through a non-data communication channel.

The method recited in the invention is for delivering media content from a first telecommunication device to a second telecommunication device. At the first step of the method, the first telecommunication device (FTD) sends a media content request to a second telecommunication device (STD). The second device checks the compatibility parameters of the first telecommunication device. If the first device is competent to receive the media content, a non-data delivery channel get utilized between the two devices and the content get delivered from the second device to the first device through the non-data channel.

The invention also discloses a system for receiving media content at a first telecommunication device from a second telecommunication device. The system includes means for sending request for media content to the second device. It also includes means for transmitting compatibility parameters of the first device to the second device. The system is capable in utilizing a non-data delivery channel between the first and second devices for media content transfer. The system also has a module for downloading and storing the requested media content from the second telecommunication device.

In an embodiment, the invention also discloses that media content can be transferred from a communication device to another communication device even in the absence of an active data connection between the two communication devices

### BRIEF DESCRIPTION OF THE DRAWINGS

These and other features, aspects, and advantages of the present invention will be better understood when the following detailed description is read with reference to the accompanying drawings in which like characters represent like parts throughout the drawings, wherein:

FIG. 1 is a flow chart illustrating method steps for receiving media content, in accordance with a described embodiment.

FIG. 2 is a diagram depicting a flow of signals between telecommunication devices, in accordance with a described embodiment of the present invention.

FIG. 3 is a diagram depicting a flow of signals between telecommunication devices, in accordance with another embodiment of the present invention.

FIG. 4 illustrates a block diagram of a system for receiving media content from a network.

While systems and methods are described herein by way of example and embodiments, those skilled in the art recognize that systems and methods for sharing media content are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

The following description is the full and informative description of the best method and system presently contemplated for carrying out the present invention that is known to the inventors at the time of filing the patent application.

The present invention relates to methods and systems for delivering media content on a hand-held device.

According to one preferred embodiment, a media content sharing system and method is described. This embodiment aids in transferring media content from one telecommunication device to another telecommunication device through a non-data channel. In other words, the method and system recited in this invention eliminates the need of an active data connection between two telecommunication devices for transferring media content.

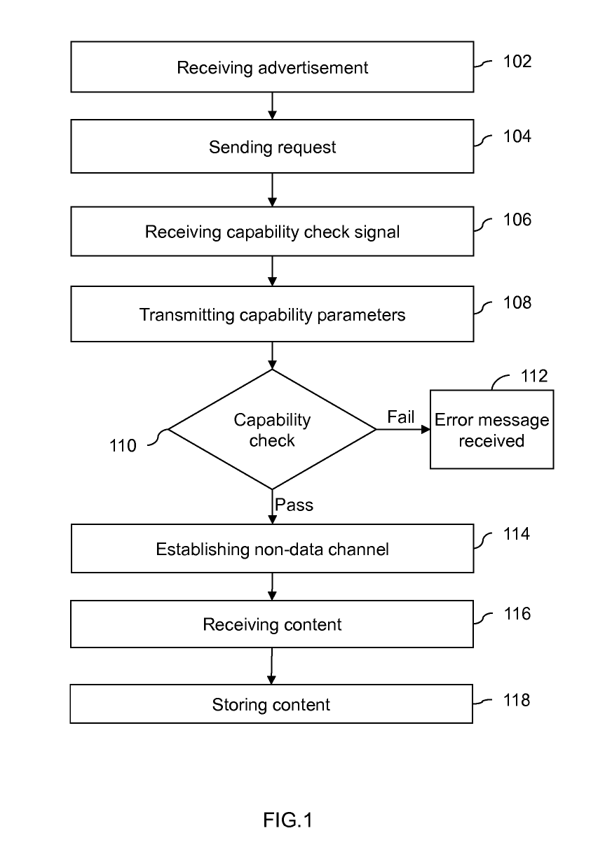

FIG. 1 is flow chart illustrating method steps for receiving media content. At first step 102 of the method, a user receives an advertisement SMS on its telecommunication device from another telecommunication device. The user device can be a mobile, or PDA, or tablet, or any hand-held device with telecommunication capabilities. The telecommunication device sending advertisement to the user device can be a content server or a server dedicated for content promotion and distribution. The advertisement received at user device includes a brief description of the media content available at the content server along with a premium SMS number for further contact. In another embodiment of the invention, the user is aware of the premium SMS number instead of receiving it through the advertisement SMS from the content server. At the next step 104, user sends a request for the media content to the premium SMS number which in turns received by a SMSC server. In response of the request for the media content, the user receives a compatibility check signal from the server at method step 106. The check signal includes queries related to the software and hardware capabilities of the user device. At method step 108, the user device parse the check signal and user device's capability parameters in accordance with the check signal are transmitted from the user device to the server. The transition of device capability parameters from user device to the content serve can be an automatic or a manual process. In other words, after receiving the check signal from the server the user device can send the device capability parameters to content server without user intervention. The compatibility parameters include type, extension, codec, size, format, screen resolution, screen size, FTD make and model, memory, etc. The content server compares the received capability parameters with the parameters required for the media content requested by the user. For the media content accessible from the content server, predefined benchmarks are available. A benchmark for particular media content includes minimum capability parameters required for a device to access the media content. After receiving the user device's capability parameters, the content server parses and compares the device capability parameters with the benchmarks associated with the requested media content, at method step 110. If the user device fail to qualify for the requested media content than the content server sends an error message to the user device, as illustrated at step 112. In other words, if the user device is not capable to receive or access the requested media content than the error message transmitted to the device from the content server. On the other hand, if the device capabilities are suitable for the requested media content i.e. if the user device passes the comparison test performed at the content server, than a non-data communication channel is utilized between the user device and the content server as mentioned at method step 114. The user device start receiving the requested content from the content server through the non-data channel between the two-telecommunication devices, at next method step 116. Once the user device completes the reception of the media content from the content server through the non-data channel, the user get charged for the media content as applicable. At the last step 118 of the method, the user device can optionally save the received media content within a memory module associated with the user device. It is well-known to a person skilled in the art that to store the received media content on the user device depends upon the rights associated with the media content.

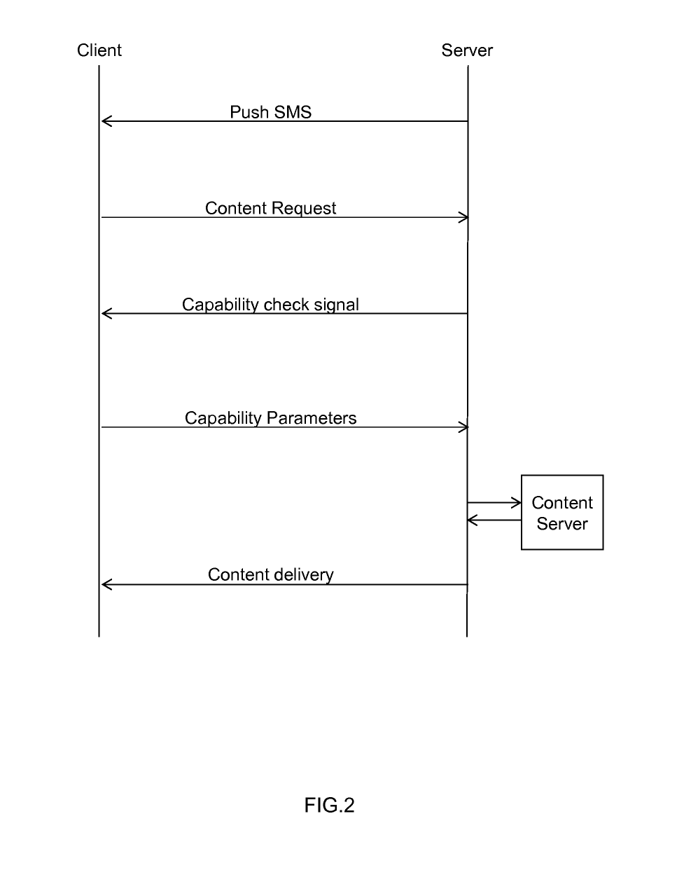

FIG. 2 is a diagram depicting a flow of signals between telecommunication devices. FIG. 2 illustrates the flow of signals between a client and a server for delivery of media content without a data connection i.e. through SMS channel that is a non-data channel. It is known to a person ordinarily skilled in the art that here server could be any content providing server with telecommunication capabilities and client could be any hand-held device with telecommunication capabilities. Initially the server push an advertisement SMS to the client. However, this can be optional as well i.e. the client can also enquire for a promotional offer. In a preferred embodiment, the client is well aware of the content available at the server that means no push SMS is required from the server. The advertisement received at client includes a brief description of media content available at the server along with a premium SMS number for further contact. In another embodiment of the invention, the client is aware of the premium SMS number instead of receiving it through the advertisement SMS from the content server. Upon receiving the push SMS, the client sends a request for the media content to the premium SMS number to the server. In response of the request for the media content, the server sends a compatibility check signal to the client. The check signal includes queries related to the software and hardware capabilities of the client. The client parsed the check signal and capability parameters in accordance with the check signal are transmitted to the server. The compatibility parameters include type, extension, codec, size, format, screen resolution, screen size, FTD make and model, memory, etc. The server compares the received capability parameters with the parameters required for the media content requested by the client. For the media content accessible from the server, predefined benchmarks are available. A benchmark for particular media content includes minimum capability parameters required for a client device to access the media content. After receiving the capability parameters, the content server parses and compares the client capability parameters with the benchmarks associated with the requested media content. If the client does not qualifies for the requested media content than the server sends an error message to the client. On the other hand, if the client capability parameters are suitable for the requested media content i.e. if the client passes the comparison test performed at the server, than a non-data communication channel is utilized between the client and the server. In turns, the client starts receiving the requested content from a content server which is in contact with the server. The client receives the content through the non-data channel between the two-telecommunication devices. The client can optionally save the received media content within a memory module associated with the client.

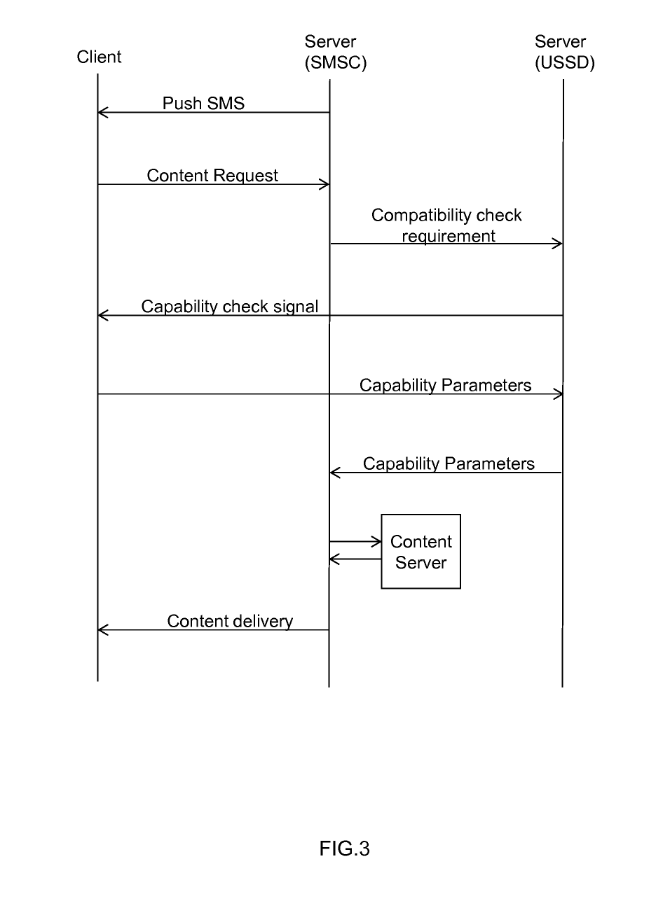

In a preferred embodiment of the invention as shown in FIG. 3, a client is receiving media content from a content server through a SMS and USSD channels. FIG. 3 illustrates a flow of signals between the client, a SMSC (Short Message Service Center) server, a USSD (Unstructured Supplementary Services Data) server and the content server. Initially SMSC server push an advertisement SMS to the client. In a preferred embodiment, the client is well aware of the content available at the server that means no push SMS is required from the SMSC server. The advertisement received at client includes a brief description of media content available at the server along with a premium SMS number for further contact. In another embodiment of the invention, the client is aware of the premium SMS number instead of receiving it through the advertisement SMS from the server. Upon receiving the push SMS, the client sends a request for the media content to the premium SMS number to SMSC server. The SMSC server sends a compatibility check requirements signal to the USSD server. The compatibility check requirements signal includes the details of the requested content received from the client. In response of the requirements signal, the USSD server sends a compatibility check signal to the client. The check signal includes queries related to the software and hardware capabilities of the client. The client parsed the check signal and capability parameters in accordance with the check signal are transmitted to the USSD server. The compatibility parameters include type, extension, codec, size, format, screen resolution, screen size, FTD make and model, memory, etc. Then the USSD server transmits the client compatibility parameters to the SMSC server. The SMSC server compares the received capability parameters with the parameters required for the media content requested by the client. For the media content accessible from the content server, predefined benchmarks are available. A benchmark for particular media content includes minimum capability parameters required for a client device to access the media content. After receiving the capability parameters, the SMSC server parses and compares the client capability parameters with the benchmarks associated with the requested media content. If the client does not qualifies for the requested media content than the server sends an error message to the client. On the other hand, if the client capability parameters are suitable for the requested media content i.e. if the client passes the comparison test performed at the SMSC server, than a non-data communication channel is utilized between the client and the SMSC server. In turns, the client starts receiving the requested content from a content server, which is in contact with the SMSC server. The client receives the content through the non-data channel utilized between the two-telecommunication devices. The client can optionally save the received media content within a memory module associated with the client.

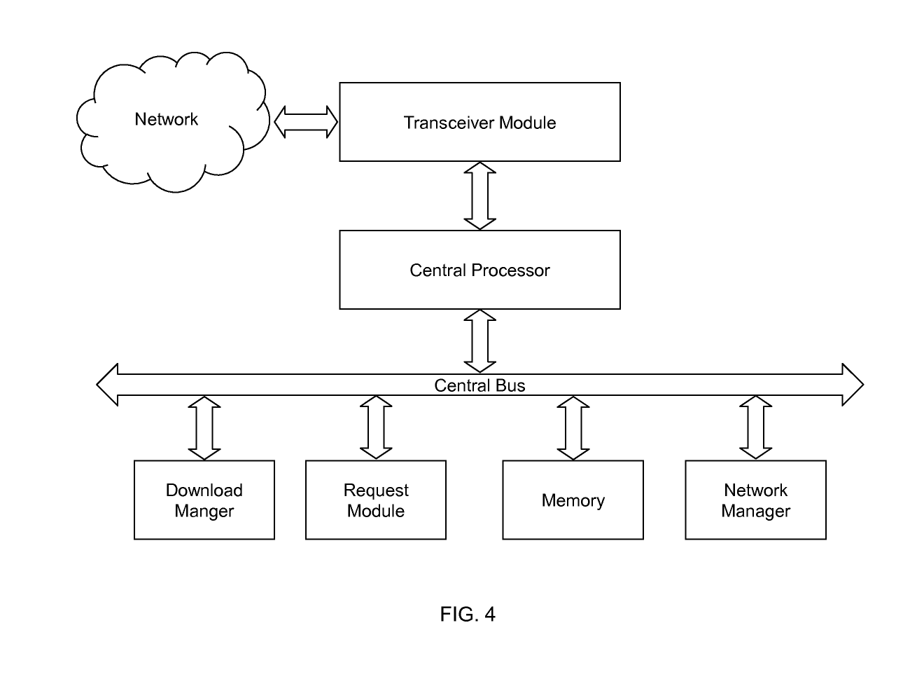

FIG. 4 illustrates a block diagram of a system for receiving media content from a network. The system illustrated in FIG. 4 can used as a telecommunication device for receiving media content from and/or transmitting media content to another telecommunication device through a communication network. The telecommunication device is connected to the communication network through a non-data channel. However, the connection between the telecommunication device and network can also be an active data connection. The telecommunication device includes a transceiver module, a central processor, a central bus, a download manager, a request module, a memory and a network manager. The transceiver module includes an antenna and a duplex switch (not shown in the figure). The transceiver receives signals and data from the central processor. The processor instructs the transceiver to send or receive data from the network by programming the duplex switch. The transceiver is connecting the telecommunication device with the external communication network through a non-data connection and/or an active data connection. The processor is the central control and processing unit of the device and connected through all other modules of the telecommunication device through the central bus. The central bus is use for communicating data and control signals between the central processor and other modules like download manager, memory, network manager and request module of the telecommunication device. The network manager is use for managing an active data connection and/or a non-data connection between the telecommunication device and the network. The request module is responsible for generating request for a desired media content. The request module either can generate request after receiving a promotional offer from the network or based on user-defined conditions. The content request generated by the request module sends to the processor through the central bus and then to the transceiver for transmitting it to the network. The download manager is responsible for downloading the media content from the network through the transceiver, the processor and the non-data channel. The functionality of the download manager depends upon the content request sent by the request module and the capabilities of the telecommunication device in accordance with the media content requested. The capability parameters of the telecommunication device are previously stored in a specific section of the memory. Once the download manager completes the download of the requested media content, the media content can optionally store in the memory associated with the central bus. In another embodiment of the invention the telecommunication device is use for transmitting the media content stored in the memory through a non-data connection utilized between the network and the transceiver module of the telecommunication device.

Embodiments of the present invention enable the delivery of media content from a first telecommunication device to a second telecommunication device in the absence of an active data channel. The present invention also enables a compatibility check process for a telecommunication device before downloading the requested media content.

The present description includes the best presently contemplated method for carrying out the present invention. Various modifications to the embodiments will be readily apparent to those skilled in the art and some features of the present invention may be used without the corresponding use of other features. Accordingly, the present invention is not intended to be limited to the embodiments shown but is to be accorded the widest scope consistent with the principles and features described herein.

As will be appreciated by those ordinary skilled in the art, the aforementioned example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code.

What is claimed is:

1. A method for delivering a media content, the method comprising:
requesting the media content from a first telecommunication device (FTD) to a second telecommunication device (STD);
checking one or more capability parameters of the first telecommunication device by the second telecommunication device;
setting up at least one delivery channel between the first telecommunication device and the second telecommunication device wherein the at least one media content delivery channel is a non-data channel; and
downloading the media content through the at least one delivery channel at the first telecommunication device.

2. The method as claimed in claim 1, wherein requesting the media content by sending a SMS.

3. The method as claimed in claim 1, wherein requesting the media content by through a USSD channel.

4. The method as claimed in claim 1, wherein requesting the media content by clicking on an advertisement.

5. The method as claimed in claim 1, wherein checking the one or more capability parameters further comprises receiving a check signal from the second telecommunication device at the first telecommunication device.

6. The method as claimed in claim 5, wherein receiving the check signal further comprising parsing of the check signal at the first telecommunication device.

7. The method as claimed in claim 6, wherein parsing of the check signal further comprising delivering a device capability report from the first telecommunication device to the second telecommunication device.

8. The method as claimed in claim 7, wherein delivering a device capability report further comprising analyzing the device capability report at the second telecommunication device.

9. The method as claimed in claim 8, wherein analyzing the device capability report at the second telecommunication device based on at least one predefined benchmarks.

10. The method as claimed in claim 9, wherein the predefined benchmark is at least one from the group comprising type, extension, codec, size, screen resolution, screen size, FTD make and model, memory, language support and format of the media content.

11. The method as claimed in claim 8, further comprising delivering an error message at the first telecommunication device from the second telecommunication device wherein the one or more capability parameters does not fullfill the one or more predefined beanchmarks.

12. The method as claimed in claim 1, wherein the delivery channel is a SMS channel

13. The method as claimed in claim 1, wherein the delivery channel is a USSD channel.

14. The method as claimed in claim 1, wherein downloading the media content further comprising storing the media content within the first telecommunication device.

15. A system for receiving a media content at a first telecommunication device, the system comprising:
means for sending a request for the media content to a second telecommunication device;
means for sending one or more capability parameters of the first telecommunication device to the second telecommunication device;
means for setting up at least one non-data communication channel between the first telecommunication device and the second telecommunication device; and
means for downloading the media content through the at least one non-data communication channel at the first telecommunication device.

16. The system as claimed in claim 15, further comprising means for receiving one or more promotional contents at the first telecommunication device.

17. The system as claimed in claim 15, wherein the capability parameter is at least one from the group comprising type, extension, codec, size, like screen resolution, screen size, FTD make and model, memory, language support and format of the media content.

18. The system as claimed in claim 15, further comprising means for receiving a request for the one or more capability parameters of the first telecommunication device by the second telecommunication device.

19. The system as claimed in claim 18, further comprising means for parsing the request for the one or more capability parameters at the first telecommunication device.

20. The system as claimed in claim 15, further comprising means for receiving an error message at the first telecommunication device from the second telecommunication device wherein the one or more capability parameters does not fullfill one or more predefined beanchmarks.

21. The system as claimed in claim 15, wherein the non-data communication channel is a SMS channel

22. The system as claimed in claim 15, wherein the non-data communication channel is a USSD channel.

23. The method as claimed in claim 15, further comprising means for storing the media content at the first telecommunication device.
